(19) United States
(12) Patent Application Publication
(10) Pub. No.: US 2020/0009712 A1
(43) Pub. Date: Jan. 9, 2020

(54) COSMETIC APPLICATOR AND DETACHABLE HANDLE

(71) Applicant: LIBO COSMETICS CO., LTD., CHANGHUA COUNTY (TW)

(72) Inventor: HSIAO-YUN LIN, CHANGHUA COUNTY (TW)

(21) Appl. No.: 16/449,918

(22) Filed: Jun. 24, 2019

Related U.S. Application Data
(60) Provisional application No. 62/694,205, filed on Jul. 5, 2018.

(51) Int. Cl. B25G 1/00; A45D 40/26; B25G 3/34

(52) U.S. Cl. CPC B25G 1/00; A45D 2040/0006; B25G 3/34; A45D 40/262

(57) ABSTRACT

The present disclosure provides a detachable handle. The detachable handle includes a grip portion, a wand portion, a first linking member, and a second linking member. The grip portion has a recess, the wand portion has a stub, the first linking member is disposed in the recess, the second linking member is disposed on the stub, and the first linking member is attached to the second linking member when the stub is received inside the recess.

### PRIORITY CLAIM AND CROSS-REFERENCE

This application claims the priority benefit of U.S. provisional application Ser. No. 62/694,205, filed on Jul. 5, 2018. The entirety of the above-mentioned patent application is hereby incorporated by reference herein and made a part of this specification.

### TECHNICAL FIELD

The present disclosure relates to an applicator and a detachable handle, and more particularly, to a cosmetic applicator and a detachable handle thereof.

### DISCUSSION OF THE BACKGROUND

The application of makeup requires the even distribution of cosmetic products. To obtain a natural-looking application, while achieving the desired enhanced appearance of the wearer's eyes, cheek or face, the cosmetics are often applied using a variety of cosmetic brushes or applicators, each having a specific cosmetic application. Makeup can also be used to conceal certain undesired colors, blemishes, birthmarks, scars, or disfigurations on the face. It is also desirable that each brush have a handle of sufficient length to permit easy application of the cosmetics.

This Discussion of the Background section is provided for background information only. The statements in this Discussion of the Background are not an admission that the subject matter disclosed in this Discussion of the Background section constitute prior art to the present disclosure, and no part of this Discussion of the Background section may be used as an admission that any part of this application, including this Discussion of the Background section, constitutes prior art to the present disclosure.

### SUMMARY

One aspect of the present disclosure provides a detachable handle. The detachable handle includes a grip portion, a wand portion, a first linking member and a second linking member. The grip portion has a recess, and the wand portion has a stub. The first linking member is disposed in the recess, the second linking member is disposed on the stub, and the first linking member is attached to the second linking member when the stub is received inside the recess.

In some embodiments, the second linking member is received in the stub and magnetically attracted to the first linking member received in the recess.

In some embodiments, the first linking member is secured within the recess by an adhesive.

In some embodiments, the second linking member is received in a hole recessed at one end of the stub close to the grip portion and secured within the hole by the adhesive.

In some embodiments, a depth of the recess is substantially equal to a sum of lengths of the stub and the first linking member.

In some embodiments, an external peripheral surface of the wand portion is flush with an external peripheral surface of the grip portion when the wand portion is received inside the recess.

In some embodiments, the recess and the stub have hexagonal cross sections.

In some embodiments, a depth of the recess extending axially into the grip is less than half of a length of the grip portion.

In some embodiments, the grip portion and the first linking member are integrally formed, and the wand portion and the second linking member are integrally formed.

In some embodiments, the second linking member threads into the first linking member when the stub is received inside the recess.

In some embodiments, the second linking member disposed on an external surface of the stub is engaged with the first linking member formed on an inner peripheral surface of the grip portion.

Another aspect of the present disclosure provides a cosmetic applicator. The cosmetic applicator includes a detachable handle and a head. The detachable handle includes a grip, a wand, a first linking member, and a second linking member. The grip portion has a recess and the wand portion has a stub. The first linking member is disposed in the recess, the second linking member is disposed on the stub, and the first linking member is attached to the second linking member when the stub is received inside the recess. The head is assembled with the wand portion of the detachable handle.

In some embodiments, the head includes a ferrule, a brush, and a sleeve; the brush is received in the ferrule, the sleeve is placed in line with the wand portion, and one end of the sleeve distal from the brush is fastened to the wand portion.

In some embodiments, the sleeve is glued onto the wand portion.

In some embodiments, the second linking member is received in the stub and magnetically attracted to the first linking member received in the recess.

In some embodiments, the first linking member is secured within the recess by an adhesive.

In some embodiments, the second linking member is received in a hole recessed at one end of the stub close to the grip portion, and the second linking member is secured within the hole by the adhesive.

In some embodiments, the second linking member threads into the first linking member when the stub is received inside the recess.

In some embodiments, the second linking member disposed on is an external surface of the stub is engaged with the first linking member formed on an inner peripheral surface of the grip portion.

The foregoing has outlined rather broadly the features and technical advantages of the present disclosure in order that the detailed description of the disclosure that follows may be better understood. Additional features and technical advantages of the disclosure are described hereinafter, and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be coupled to the figures' reference numbers, which refer to similar elements throughout the description.

FIG. 1 is an exploded view of a cosmetic applicator in accordance with some embodiments of the present disclosure.

FIG. 2 is an assembled view of the cosmetic applicator in accordance with some embodiments of the present disclosure.

FIG. 3 is a perspective view of the cosmetic applicator of FIG. 2 with a portion of the detachable handle shown as being cut longitudinally.

FIG. 4 is an exploded view of a detachable handle in accordance with some embodiments of the present disclosure.

FIG. 5 is a perspective view of the detachable handle of FIG. 4 with a portion of the detachable handle shown as being cut longitudinally.

FIG. 6 is an exploded view of a detachable handle in accordance with some embodiments of the present disclosure.

FIG. 7 is a perspective view of the detachable handle of FIG. 6 with a portion of the detachable handle shown as being cut longitudinally.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

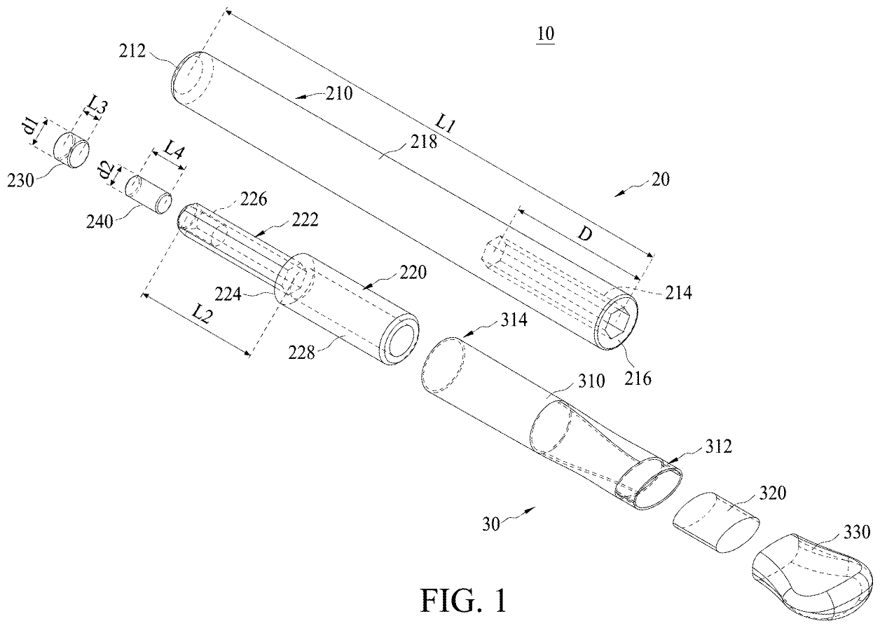

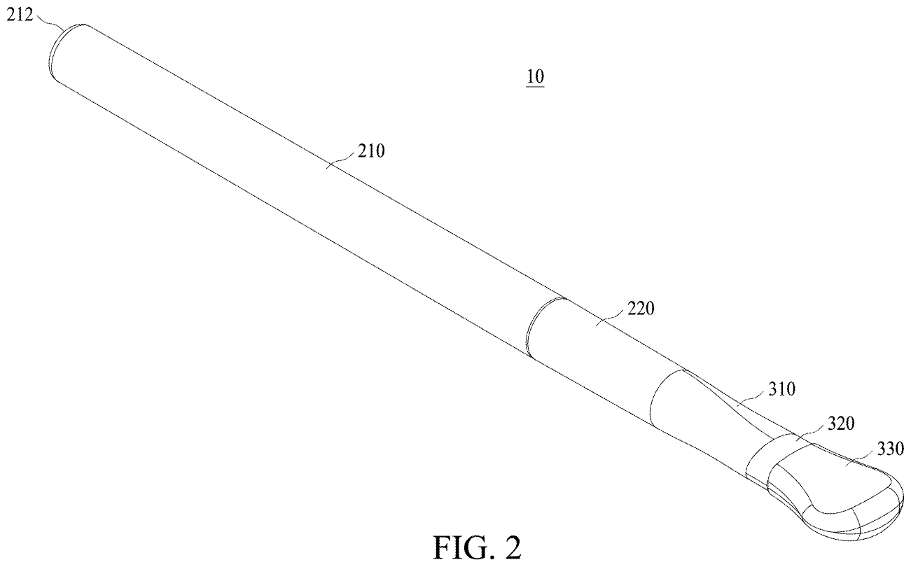

FIG. 1 is an exploded view of a cosmetic applicator 10 in accordance with some embodiments, and FIG. 2 is an assembled view of the cosmetic applicator 10 in accordance with some embodiments of the present disclosure. Referring to FIGS. 1 and 2, the cosmetic applicator 10 includes a detachable handle 20 and a head 30 assembled with the detachable handle 20. In some embodiments, the cosmetic applicator 10 may be used for applying one or more cosmetic products, such as blush, eye shadow, and camouflage or concealer.

In some embodiments, the detachable handle 20 includes a grip portion 210, a wand portion 220, a first linking member 230 and a second linking member 240. In some embodiments, the grip portion 210 placed in line with the wand portion 220 can be detachably mounted to the wand portion 220. In some embodiments, the head 30 placed in line with the wand portion 220 is coupled to another end of the wand portion 220, opposite to the grip portion 210. In some embodiments, the wand portion 220 and the head 30 engaged with the wand portion 220 may be attached to or detachable from the grip portion 210.

In some embodiments, the grip portion 210 has a sufficient length to permit easy application of the cosmetic product. In some embodiments, the grip portion 210 is substantially linear and cylindrical in shape. In some embodiments, the grip portion 210 has a round cross section. In some embodiments, the grip portion 210 may have an oval cross section or a polygonal cross section to resist rolling. In some embodiments, the grip portion 210 may have a uniform diameter along its length. Alternatively, the grip portion 210 may vary its cross-sectional dimension or shape along its length. For example, the grip portion 210 may taper from the wand portion 220 to a free end 212 opposite to the wand portion 220. In some embodiments, the grip portion 210 may be formed of plastic, ceramic, metal, wood or other material.

In some embodiments, the grip portion 210 includes a recess 214 at the end opposite to the free end 212 for accommodating a portion of the wand portion 220. In some embodiments, a depth D of the recess 214 extending axially into the grip portion 210 is less than half of a length L1 of the grip portion 210.

In some embodiments, the wand portion 220 is generally cylindrical. In some embodiments, the wand portion 220 includes a stub 222 at an end of the wand portion 220 distal from the head 30. In some embodiments, the stub 222 is received inside the recess 214 when the wand portion 220 is assembled with the grip portion 210. In some embodiments, the recess 214 is shaped and sized to fit tightly over the stub 222. For example, if the stub 222 has a hexagonal cross section, the recess 214 may have a similarly hexagonal cross section; in this manner, a contacting area of the grip portion 210 and the wand portion 220 is increased, such that the grip portion 210 and the wand portion 220 are tightly engaged and not prone to easily come apart. In some embodiments, the stub 222 may have a circular cross section or a polygonally shaped of cross section, and the recess 214 may have a correspondingly circular or polygonal cross section such as to fit tightly over the stub 222. In some embodiments, when the stub 222 is inserted into the recess 214, a surface 224 of the wand portion 220 is in contact with an end surface 216 of the grip portion 210. In some embodiments, the wand portion 220 immediately adjacent to the stub 222 is sized such that an outer peripheral surface 228 of the wand portion 220 is flush with an outer peripheral surface 218 of the grip portion 210.

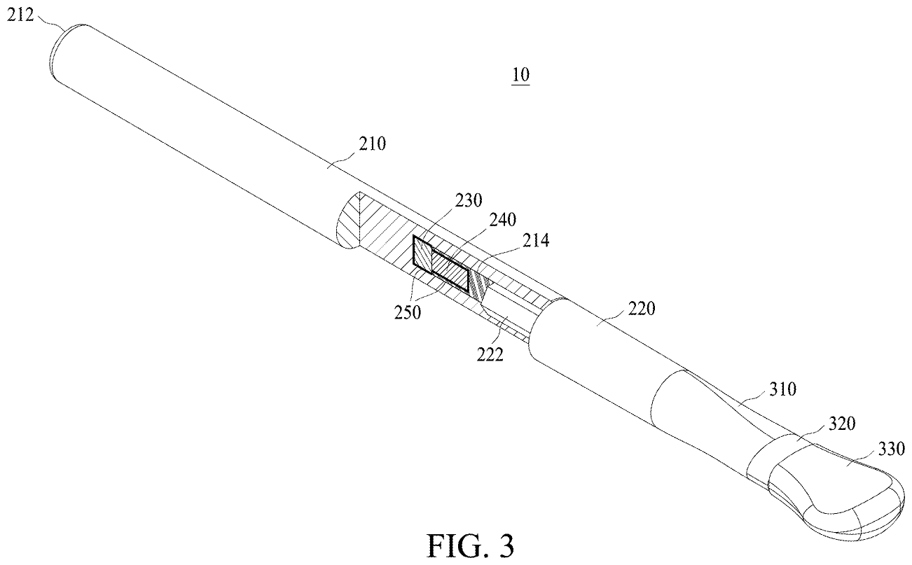

FIG. 3 is a perspective view of the cosmetic applicator of FIG. 2 with a portion of the detachable handle 20 shown as being cut longitudinally. Referring to FIGS. 1 to 3, in some embodiments, the first linking member 230 and the second linking member 240 are permanent magnets. In some embodiments, the first linking member 230 is disposed in the recess 214, and the second linking member 240 is embedded in the stub 222. In some embodiments, the first linking is member 230 received in the grip portion 210 and the second linking member 240 received in the stub 222 have opposite polarities (N and S) facing each other, such that the first linking member 230 will magnetically attract the second linking member 240 when the stub 222 is received inside to recess 214, thereby preventing a loose engagement of the wand portion 220 with the grip portion 210.

In some embodiments, the first linking member 230 and the second linking member 240 are cylindrical. In some embodiments, the first linking member 230 has a first diameter d1 and a first length L3, and the second linking member 240 has a second diameter d2 substantially less than the first diameter d1 and a second length L4 substantially greater than the first length L3. In some embodiments, the depth D of the recess 214 is substantially equal to a sum of a length L2 of the stub 222 and the length L3 of the first linking member 230. In other embodiments, the first linking member 230 and the second linking member 240 may have other shapes, such as hexagonal, in order to force-fit into the recess 214.

In some embodiments, it is possible for the first linking member 230 to be fastened to the recess 214 by way of force-fit. Alternatively, the first linking member 230 is secured within the recess 214 by an adhesive 250, such as glue, for preventing the first linking member 230 from falling out of the recess 232. In some embodiments, a hole 226 is formed at one end of the stub 222 distal from the head 30 for accommodating the second linking member 240. In some embodiments, it is possible for the second linking member 240 to be fastened to the hole 226 by way of the adhesive 250 or by force-fit.

Referring again to FIGS. 1 and 2, the head 30 includes a sleeve 310, a ferrule 320 and a brush 330 received in the ferrule 320. In some embodiments, the sleeve 310 has a front end 312 that is shaped and sized to fit tightly over the ferrule 320, and a rear end 314 of the sleeve 310 is circular and of the same diameter as the wand portion 220.

In some embodiments, the sleeve 310 is placed in line with the wand portion 220, and one end of the sleeve 310 distal from the brush 330 is a tight fit on the wand portion 220. In some embodiments, the sleeve 310 may be glued onto the wand portion 220.

In some embodiments, the ferrule 320 may be adhesively bonded or clamped within another end of the sleeve 310 distal from the wand portion 220. In some embodiments, the ferrule 320 is made of metal. In some embodiments, the ferrule 320 is made of soft, lightweight metal for economy purpose, such as aluminum. In some embodiments, the aluminum may be either bare or coated with a decorative covering, such as paint, varnish, or other suitable material that adheres to the ferrule 320. In some embodiments, the aluminum may have a sufficient thickness to be sufficiently strong and rigid to support the forces exerted during use. In some embodiments, the ferrule 320 may be made of common metals for such purpose, including tin, nickel, brass or any alloy thereof In some embodiments, the ferrule 320 may also be made of plastic or polymer.

In some embodiments, the brush 330 is secured to the ferrule 320 in any suitable way, for example, by adhesively bonding. In some embodiments, the brush 330 includes a variety of sizes and shapes, and the brush 330 is designed for a specific application or area of the face. In some embodiments, the brush 330 may include hair, bristles or fibers. In some embodiments, the brush 330 varies in length, such that the tip of the brush 330 is curved, is angled, or is another desired shape to conform to the contours of the eye, cheek or any area on the face.

In conclusion, with the configuration of detachable handle 10, the magnetic attracting force of the first linking member 230 and the second linking member 240 can keep the grip portion 210 and the wand portion 220 securely locked, and coupling and detaching the grip portion 210 and the wand portion 220 can be accomplished very easily.

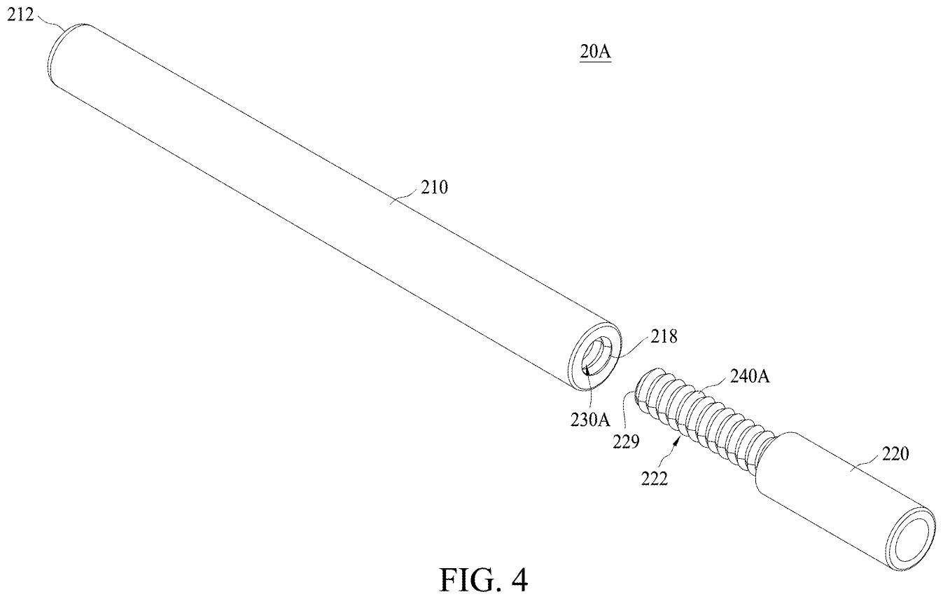

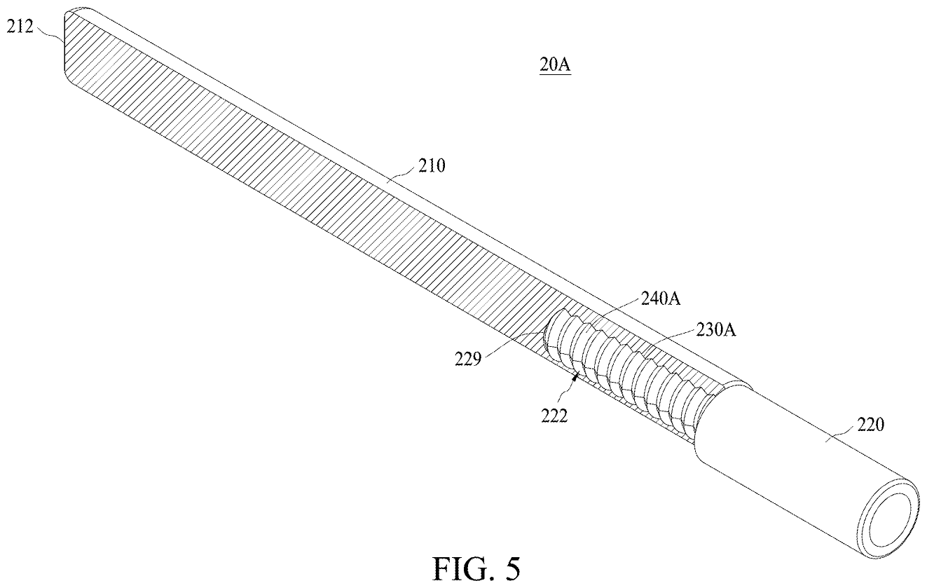

FIG. 4 is an exploded view of a detachable handle 20A in accordance with some embodiments of the present disclosure, and FIG. 5 is a perspective view of the detachable handle 20A of FIG. 4 with a portion of the detachable handle shown as being cut longitudinally. Referring to FIGS. 4 and 5, in some embodiments, the detachable handle 20A has a configuration similar to that of the detachable handle 20 illustrated in FIGS. 1 to 3. In some embodiments, a first linking member 230A and a second linking member 240A are threaded. Specifically, the first linking member 230A is provided on an inner peripheral surface 218 of the grip portion 210, the second linking member 240A is provided on an external surface 229 of the stub 222, and the second linking member 240A threads into the first linking member 230A to prevent a loose engagement of the wand portion 220 with the grip portion 210. In some embodiments, the grip portion 210 and the first linking member 230A are integrally formed, and the wand portion 220 and the second linking member 240A are integrally formed.

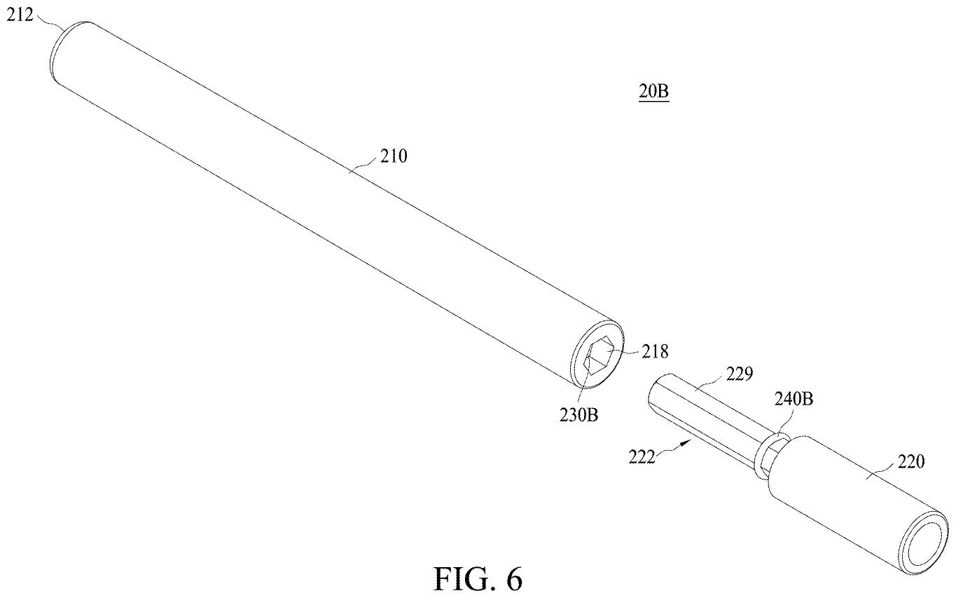

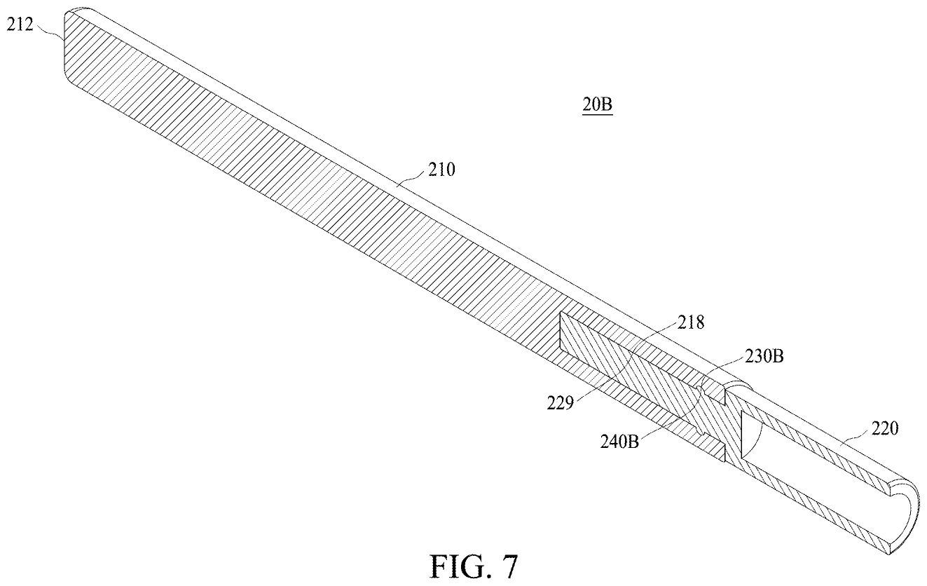

FIG. 6 is an exploded view of a detachable handle 20B in accordance with some embodiments of the present disclosure, and FIG. 7 is a perspective view of the detachable handle 20B of FIG. 6 with a portion of the detachable handle shown as being cut longitudinally. Referring to FIGS. 6 and 7, in some embodiments, the detachable handle 20B has a configuration similar to that of the detachable handle 20 illustrated in FIGS. 1 to 3. In some embodiments, the first linking member 230B is a groove integrally formed on an inner peripheral surface 218 of the grip portion 210, the second linking portion 240B is a protrusion integrally formed on an external surface 229 of the stub 222, and the second linking member 240B is engaged with the first linking member 230B to prevent a loose engagement of the wand portion 220 with the grip portion 210.

One aspect of the present disclosure provides a detachable handle. The detachable handle includes a grip portion, a wand portion, a first linking member, and a second linking member. The grip portion has a recess, and the wand portion has a stub. The first linking member is disposed in the recess, the second linking member is disposed on the stub, and the first linking member is attached to the second linking member when the stub is received inside the recess.

One aspect of the present disclosure provides a cosmetic applicator. The cosmetic applicator includes detachable handle and a head. The detachable handle includes a grip portion, a wand portion, a first linking member, and a second linking member. The grip portion has a recess, and the wand portion has a stub. The first linking member is disposed in the recess, the second linking member is disposed on the stub, and the first linking member is attached to the second linking member when the stub is received inside the recess. The head is assembled with the wand portion of the detachable handle.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods and steps.

What is claimed is:

1. A detachable handle, comprising:
a grip portion having a recess;
a wand portion having a stub;
a first linking member disposed in the recess; and
a second linking member disposed on the stub;
wherein the first linking member is attached to the second linking member when the stub is received inside the recess.

2. The detachable handle of claim 1, wherein the second linking member is received in the stub and magnetically attracted to the first linking member received in the recess.

3. The detachable handle of claim 2, wherein the first linking member is secured within the recess by an adhesive.

4. The detachable handle of claim 3, wherein the second linking member is received in a hole recessed at one end of the stub close to the grip portion and secured within the hole by the adhesive.

5. The detachable handle of claim 2, wherein a depth of the recess is substantially equal to a sum of lengths of the stub and the first linking member.

6. The detachable handle of claim 1, wherein an outer peripheral surface of the wand portion is flush with an outer peripheral surface of the grip portion when the wand portion is received inside the recess.

7. The detachable handle of claim 1, wherein the recess and the stub have hexagonal cross sections.

8. The detachable handle of claim 1, wherein a depth of the recess extending axially into the grip is less than half of a length of the grip portion.

9. The detachable handle of claim 1, wherein the grip portion and the first linking member are integrally formed, and the wand portion and the second linking member are integrally formed.

10. The detachable handle of claim 9, wherein the second linking member threads into the first linking member when the stub is received inside the recess.

11. The detachable handle of claim 9, wherein the second linking member disposed on an external surface of the stub is engaged with the first linking member formed on an inner peripheral surface of the grip portion.

12. A cosmetic applicator, comprising:
a detachable handle comprising:
a grip portion having a recess;
a wand portion having a stub;
a first linking member disposed in the recess; and
a second linking member disposed on the stub, wherein the first linking member attaches to the second linking member when the stub is received inside the recess; and
a head assembled with the wand portion of the detachable handle.

13. The cosmetic applicator of claim 12, wherein the head comprises:
a ferrule;
a brush received in the ferrule; and
a sleeve placed in line with the wand portion, wherein one end of the sleeve distal from the brush is fastened to the wand portion.

14. The cosmetic applicator of claim 12, wherein the sleeve is glued onto the wand portion.

15. The cosmetic applicator of claim 12, wherein the second linking member is received in the stub and magnetically attracted to the first linking member received in the recess.

16. The cosmetic applicator of claim 12, wherein the first linking member is secured within the recess by an adhesive.

17. The cosmetic applicator of claim 12, wherein the second linking member is received in a hole recessed at one end of the stub close to the grip portion, and the second linking member is secured within the hole by the adhesive.

18. The cosmetic applicator of claim 12, wherein the second linking member threads into the first linking member when the stub is received inside the recess.

19. The cosmetic applicator of claim 12, wherein the second linking member disposed on an external surface of the stub is engaged with the first linking member formed on an inner peripheral surface of the grip portion.
